(19) United States
(12) Patent Application Publication
(10) Pub. No.: US 2025/0369854 A1
(43) Pub. Date: Dec. 4, 2025

(54) METHOD AND SYSTEM FOR MONITORING THE PERFORMANCE OF AN OIL FILTER OF AN AIRCRAFT

(71) Applicant: Airbus Operations (S.A.S.), Toulouse (FR)

(72) Inventors: Quentin Teulet, Toulouse (FR); Vincent Frede, Toulouse (FR)

(21) Appl. No.: 19/215,807

(22) Filed: May 22, 2025

(30) Foreign Application Priority Data
May 29, 2024 (FR) FR2405547

(51) Int. Cl. G01N 15/08; F02C 7/06

(52) U.S. Cl. CPC G01N 15/08; F02C 7/06; G01N 2015/084

(57) ABSTRACT

A method for monitoring performance of an oil filter of an aircraft includes for at least one predetermined measurement time, acquiring a measured temperature value and a measured differential pressure value of oil passing through the oil filter, estimating, for the one or each measurement time, a reference differential pressure value using a prediction model and the measured temperature value, computing, for the one or each measurement time, a comparison value between the measured differential pressure value and the reference differential pressure value, and triggering an alert if a trigger condition, which is dependent on the one or more comparison values computed for the one or more measurement times, is met. Thus, the performance of the filter is monitored using an indicator that is reliable and easy to compute.

### TECHNICAL FIELD

The field of the disclosure herein is that of health monitoring and maintenance of aircraft.

More specifically, the disclosure herein relates to a method for monitoring the performance of an oil filter of an aircraft.

The disclosure herein also relates to a monitoring system adapted to implement such a method, as well as a computer program product and a storage medium for implementing such a method.

### BACKGROUND

Aircraft experience extreme conditions when flying, notably in terms of variations in temperature, pressure and speed. The performance capabilities of their components must be regularly checked in order to ensure they are working properly.

Preventive or predictive maintenance involves carrying out checks and repairs before a fault occurs.

In the field of aeronautics, maintenance notably improves the availability and the performance of an aircraft by preventing it from being grounded (AOG, “Aircraft On Ground”) and reduces maintenance costs by identifying maintenance operations in advance based on the actual performance capabilities of the aircraft.

Monitoring the health of an aircraft for maintenance purposes involves gathering technical data from the moment the aircraft is powered up, then during flight and until it is shut down. The data gathered in this way are notably used to compute the various indicators the maintenance is based on, and therefore to schedule maintenance operations.

The data can be used during a flight (known as “in-flight health monitoring”) and/or after a flight (for example, if the amount of data to be processed requires greater computing resources).

In addition, computations using the gathered data can be performed in the aircraft and/or in one or more items of ground-based equipment. In the latter case, the ground-based equipment (computers) receives the data gathered in the aircraft in real time or at a later time.

Monitoring the state of health of an aircraft over several flights allows ground crew to make decisions and to plan maintenance operations in advance, saving valuable execution time. The ground crew can thus make appropriate decisions based on the criticality, the logistics and any forthcoming maintenance checks, and can prepare repairs and replacements in advance.

Within the context of the maintenance, there is a particular need to monitor the performance of the oil filters of the aircraft. This requires the provision of a performance indicator for an oil filter of an aircraft that is reliable and easy to compute.

### SUMMARY

A method is disclosed herein for monitoring the performance of an oil filter of an aircraft, the aircraft being equipped with a temperature sensor and a differential pressure sensor, respectively providing measured temperature values and measured differential pressure values of the oil passing through the oil filter, the method being implemented by a system for monitoring the performance of the oil filter in the form of electronic circuitry, the method comprising:
for at least one predetermined measurement time, acquiring a measured temperature value and a measured differential pressure value of the oil passing through the oil filter;
estimating, for the one or each measurement time, a reference differential pressure value using a prediction model and the measured temperature value;
computing, for the one or each measurement time, a comparison value between the measured differential pressure value and the reference differential pressure value; and
triggering an alert if a trigger condition, which is dependent on the one or more comparison values computed for the one or more measurement times, is met.

Thus, it is possible to monitor the performance of an oil filter of an aircraft using an oil filter performance indicator that is reliable and easy to compute.

According to a particular embodiment, the prediction model is a polynomial law intended to approximate pairs of values, comprising a measured temperature value and a measured differential pressure value, measured at predefined measurement times during flights preceding a current flight, and expressing a reference differential pressure value of the oil as a function of the oil temperature.

According to a particular embodiment, at least two comparison values are computed for at least two measurement times. The method further comprises: determining a value forming an indicator as a function of the at least two computed comparison values. The trigger condition is a function of the value forming an indicator.

According to a particular embodiment, the method comprises normalizing the value forming an indicator in order to obtain a normalized value forming an indicator, and the trigger condition is a function of the normalized value forming an indicator.

According to a particular embodiment, the operations prior to triggering an alert and resulting in the determination of a value forming an indicator are repeated N times, for N successive flights, with N>2, in order to obtain N values forming an indicator. Furthermore, the trigger condition is that an average of the N values forming an indicator is greater than a threshold value.

According to a particular embodiment, the at least one predetermined measurement time belongs to a study time zone comprising one or more study sub-time zones defined as a function of at least one criterion belonging to the group comprising:
a criterion dependent on a flight phase parameter of the aircraft;
a criterion dependent on an altitude parameter of the aircraft; and
a criterion dependent on a parameter of the speed N2 of rotation of a high-pressure rotor of an engine of the aircraft.

In a first specific implementation, the computation of a comparison value comprises, for each measurement time, a computation of a deviation between the measured differential pressure value and the reference differential pressure value. In addition, the value forming an indicator is the differential pressure value measured at the measurement time at which the computed deviation is minimal.

In a second specific implementation, the aircraft is equipped with a speed N2 sensor providing values of the speed N2 of rotation of a high-pressure rotor of an engine of the aircraft. A measured speed N2 value is also acquired for each measurement time. The estimation, for each measurement time, of a reference differential pressure value using the prediction model and the measured temperature value is also performed using the measured speed N2 value. The computation of a comparison value comprises, for each measurement time, computing a ratio between the measured differential pressure value and the reference differential pressure value. The value forming an indicator is the median value of the ratios computed for the at least two measurement times.

A computer program product is also disclosed, comprising instructions causing a processor to execute the aforementioned method according to any one of its embodiments when the instructions are executed by the processor.

A storage medium is also disclosed for storing such instructions.

A system is also disclosed for monitoring the performance of an oil filter of an aircraft, the aircraft being equipped with a temperature sensor and a differential pressure sensor, respectively providing measured temperature values and measured differential pressure values of the oil passing through the oil filter, the monitoring system comprising electronic circuitry configured to implement the following:
for at least one predetermined measurement time, acquiring a measured temperature value and a measured differential pressure value of the oil passing through the oil filter;
estimating, for the one or each measurement time, a reference differential pressure value using a prediction model and the measured temperature value;
computing, for the one or each measurement time, a comparison value between the measured differential pressure value and the reference differential pressure value; and
triggering an alert if a trigger condition, which is dependent on the one or more comparison values computed for the one or more measurement times, is met.

An aircraft is also disclosed comprising at least one oil filter and the aforementioned system for monitoring the performance of an oil filter (in any one of its various embodiments).

### BRIEF DESCRIPTION OF THE DRAWINGS

The features of the disclosure herein mentioned above, as well as other features, will become more clearly apparent upon reading the following description of at least one embodiment, with the description being provided with reference to the accompanying drawings, in which:

FIG. 1 schematically illustrates, as a side view, an aircraft equipped with a system for monitoring the performance of one (or more) oil filters of an aircraft;

FIG. 2 schematically illustrates an example of the hardware architecture of the system for monitoring the performance of one (or more) oil filters of an aircraft;

FIG. 3 schematically illustrates an example of an algorithm for monitoring the performance of an oil filter of an aircraft; and

FIG. 4 schematically illustrates an example of a polynomial law expressing a reference differential pressure value of the oil as a function of the oil temperature.

### DETAILED DESCRIPTION

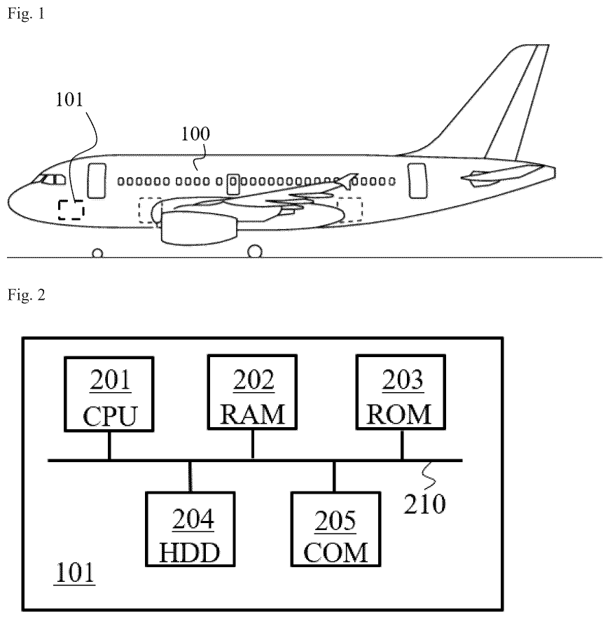

FIG. 1 schematically illustrates, as a side view, an aircraft 100 equipped with one or more oil filters (not shown) and a system 101 for monitoring the performance of this or these oil filters.

An oil filter is a consumable cartridge that collects particles released into the oil circuit of an engine. For example, an aircraft includes a main filter, as well as a backup filter for filtering the oil if the main filter becomes clogged. The oil filters are regularly replaced to ensure optimal filtration.

For each oil filter, the aircraft 100 is equipped, for example, with a temperature sensor and a differential pressure sensor (not shown), respectively providing temperature values (denoted “V_OIL”) and differential pressure values (denoted “V_OFDP”, with OFDP being the acronym for “Oil Filter Delta Pressure”) of the oil passing through the oil filter.

The aircraft 100 is also equipped with a speed N2 sensor, which provides values of the speed N2 of rotation of a high-pressure rotor of the engine of the aircraft (denoted “V_N2”).

The system 101 for monitoring the performance of the one or more oil filters is an on-board electronic device. For example, it forms part of an electronic circuit in the avionics of the aircraft 100. Preferably, it is integrated into a computer in the aircraft 100.

In a variant, the aircraft 100 comprises several systems 101, each of which monitors the performance of an oil filter.

In another variant, the system 101 for monitoring the performance of one or more oil filters is not on board the aircraft 100 but is located on the ground.

In another variant, the system 101 for monitoring the performance of one or more oil filters comprises a first part that is on board the aircraft 100 and a second part that is on the ground. Thus, the computations of the performance indicator and the triggering of alerts can be distributed between the two parts of the system 101. For example, the first part computes the value of the performance indicator and the second part triggers the alerts.

In another variant, at least one system 101 for monitoring the performance of one or more oil filters is on board the aircraft and at least one system 101 for monitoring the performance of one or more oil filters is installed on the ground.

FIG. 2 schematically illustrates an example of the hardware architecture of the system 101 for monitoring the performance of one or more oil filters, which then comprises, connected by a communication bus 210: a processor or CPU (Central Processing Unit) 201; a RAM (Random Access Memory) 202; a ROM (Read Only Memory) 203, for example, a Flash memory; a data storage device, such as an HDD (Hard Disk Drive), or a storage medium reader, such as a Secure Digital (SD) card reader 204; at least one communication interface 205 allowing the system 101 for monitoring the performance of one or more oil filters to interact with the avionics of the aircraft 100.

The processor 201 is capable of executing instructions loaded into the RAM 202 from the ROM 203, from an external memory (not shown), from a storage medium, such as an SD card, or from a communication network (not shown). When the system 101 for monitoring the performance of one or more oil filters is powered up, the processor 201 is capable of reading instructions from the RAM 202 and of executing them. These instructions form a computer program causing the processor 201 to implement the behaviors, steps and the algorithms described herein.

All or some of the behaviors, steps and algorithms described herein thus can be implemented in software form by executing a set of instructions using a programmable machine, such as a DSP (Digital Signal Processor) or a microcontroller, or can be implemented in hardware form by a dedicated machine or component (“chip”) or a set of dedicated components (“chipset”), such as an FPGA (“Field-Programmable Gate Array”) or an ASIC (“Application-Specific Integrated Circuit”). In general, the system 101 for monitoring the performance of one or more oil filters comprises electronic circuitry arranged and configured to implement the behaviors, steps and algorithms described herein.

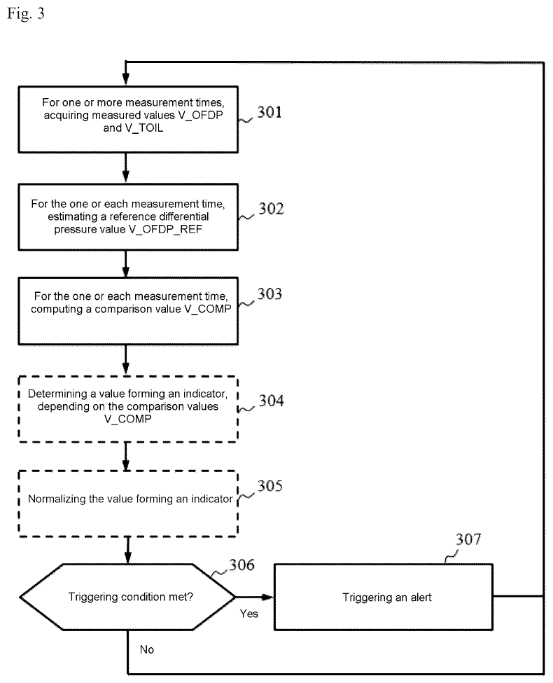

FIG. 3 schematically illustrates an example of an algorithm for monitoring the performance of an oil filter of an aircraft. It is executed by the system for monitoring the performance of one (or more) oil filters, reference 101 in FIG. 1. Throughout the remainder of the description, monitoring the performance of a single oil filter is considered.

In a step 301, the system 101 acquires (301), at one or more predetermined measurement times, a measured temperature value V_TOIL and a measured differential pressure value V_OFDP of the oil passing through the oil filter, which values are measured by the sensors (temperature sensor and differential pressure sensor) and form a pair of measured values (V_TOIL, V_OFDP). The one or more measurement times (also called “timestamp values”) belong to a study time zone (also called “stabilised zone”).

In an embodiment, the study time zone comprises one or more study sub-time zones defined according to one or more of the following criteria:
a criterion dependent on a flight phase parameter of the aircraft (the value assumed by this parameter, at a measurement time, is denoted “V_FLIGHT_PHASE”);
a criterion dependent on an altitude parameter of the aircraft (the value assumed by this parameter, at a measurement time, is denoted “V_ALTITUDE”); and
a criterion dependent on a parameter of the speed N2 of rotation of a high-pressure rotor of an engine of the aircraft (as already discussed above, the value assumed by this parameter, at a measurement time, is denoted “V_N2”).

In a particular implementation, the study time zone includes the measurement times at which the following three criteria are met:

V_FLIGHT_PHASE=6, this value 6 indicates that the aircraft is in a cruising phase;

$$Rolling\_Max ( V\_ALTITUDE ) - Rolling\_Min ( V\_ALTITUDE ) <= 50 ft ;$$

$$and$$

$$Rolling\_Max ( V\_N2 ) - Rolling\_Min ( V\_N2 ) <= 5 \% ;$$

with the Rolling_Max (X) function and the Rolling_Min (X) function respectively feeding back the maximum value and the minimum value of a parameter X over a sliding window (for example, of 120 s).

In a step 302, the system 101 estimates, for the one or each measurement time, a reference differential pressure value V_OFDP_REF, using a prediction model and the measured temperature value V_TOIL.

In an embodiment, the prediction model is a polynomial law aimed at approximating pairs of values, comprising a measured temperature value V_TOIL and a measured differential pressure value V_OFDP, measured at predefined measurement times during flights preceding a current flight, and expressing a reference differential oil pressure value V_OFDP_REF as a function of the oil temperature.

The polynomial law is expressed, for example, as: V_OFDP_REF=f(V_TOIL).

It is determined in a preliminary phase of developing the prediction model by processing a significant amount of flight data originating from one or more aircraft. It then can be used in step 302 of this algorithm (illustrated in FIG. 3) to monitor the performance of an oil filter of an aircraft.

In a step 303, the system 101 computes, for each measurement time at which a given pair of measured values (V_TOIL, V_OFDP) is measured, a comparison value V_COMP between the measured differential pressure value V_OFDP and the reference differential pressure value V_OFDP_REF (provided by the polynomial law for the temperature value V_TOIL of the given pair of measured values).

In a step 304, the system 101 determines a value forming an indicator V_INDIC as a function of the comparison values V_COMP computed for the various measurement times.

In a step 305, the system 101 normalizes the value forming an indicator V_COMP in order to obtain a normalized value forming an indicator V_INDIC_NORM.

In a step 306, the system 101 detects whether an alert triggering condition, as a function of the normalized value forming an indicator V_INDIC_NORM, is met, and if so, proceeds to step 307, in which it triggers an alert, otherwise it returns to step 301. The alert is associated with a preventive maintenance operation relating to the oil filter and indicates, for example, a clogged state of the filter and, if applicable, whether the filter is in an advanced clogged state.

In a variant, the system 101 acquires values at a single measurement time and therefore acquires only one pair of measured values (V_TOIL, V_OFDP). Then, for this single measurement time, the system 101 estimates (in step 302) a single reference differential pressure value V_OFDP_REF and then computes (in step 303) a single comparison value V_COMP. In this variant, steps 304 and 305 are omitted and, in step 306, the system 101 detects whether an alert trigger condition, depending on the single comparison value V_COMP (possibly normalized), is met.

The alert trigger condition relates, for example, to the fact that an average of the last N normalized values forming an indicator is greater than a threshold value, with N>2. In this case, the normalized value forming an indicator V_INDIC_NORM resulting from the execution of steps 301 to 305 is used, with the “average” operator, together with the N−1 previous values resulting from the N−1 previous iterations of the same steps 301 to 305 (therefore, for the N−1 previous time study zones).

In a variant, the system 101 manages two alert levels (for example, alerts sent to an electronic centralised aircraft monitoring system (ECAM (Electronic Centralized Aircraft Monitor)) to inform the crew and/or the airline), each with a different alert threshold. In other words, if the (first) trigger alert condition in step 306 is not met, the system 101 does not return to step 301 but proceeds to a step (not shown) in which it detects whether a second alert trigger condition (also based on the normalized value forming an indicator V_INDIC_NORM, but with a different threshold value) is met, and if so, it proceeds to a step (not shown) in which it triggers a second alert, otherwise it returns to step 301.

Thus, it is possible to trigger various types of alerts (two in the embodiment described above, but in variants there may be more than two) depending on the value of the indicator V_INDIC_NORM and therefore on the severity level (risk level). Each type of alert can be associated with preventive maintenance operations that are appropriate for the risk level of the considered alert. For example, the period in which the oil filter needs to be replaced is shorter, the higher the risk.

In one variant, the normalization step 305 is omitted and, as a result, the trigger condition (met in step 306) depends on the value forming an indicator V_COMP.

### First Specific Implementation

A first specific implementation of the algorithm in FIG. 3 will now be described.

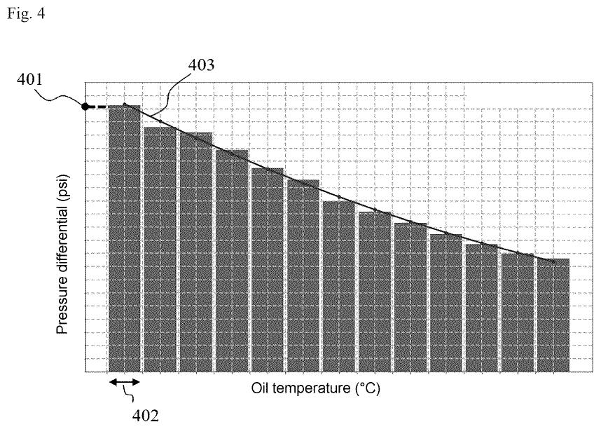

In a preliminary phase, not shown and executed before the algorithm in FIG. 3, the prediction model is developed by processing a significant amount of data relating to flights previously taken by one or more aircraft. As illustrated in FIG. 4, for pairs of values (V_TOIL, V_OFDP) measured at times within study time zones, included in the time periods of flights previously taken by one or more aircraft, the differential pressure values V_OFDP are sorted according to their associated temperature values V_TOIL (i.e., from the same pair). Next, for each range of oil temperature values with an interval of 2° C. (see, for example, the range with reference sign 402), an average value of the differential pressure values V_OFDP is computed (see, for example, the average differential pressure value V_OFDP, reference sign 401, for the temperature range with reference sign 402). Finally, the polynomial law (reference sign 403) is defined by a polynomial regression.

In a phase of executing the algorithm in FIG. 3 (algorithm for monitoring the performance of an oil filter of an aircraft), the prediction model (previously developed as described above) is used in step 302 by the system 101 to estimate, for each measurement time, a reference differential pressure value V_OFDP_REF.

Then, in step 303, the computation of a comparison value V_COMP includes, for each measurement time at which a given pair of measured values (V_TOIL, V_OFDP) is measured, a computation of a deviation DELTA between the measured differential pressure value V_OFDP and the reference differential pressure value V_OFDP_REF (provided by the polynomial law for the measured temperature value V_TOIL):

$$DELTA = V\_OFDP \_REF - V\_OFDP .$$

In step 304, the value forming an indicator V_INDIC is the differential pressure value V_OFDP of the pair whose values (V_TOIL, V_OFDP) were measured at the measurement time for which the computed deviation DELTA is minimal.

### Second Specific Implementation

A second specific implementation of the algorithm in FIG. 3 will now be described. This differs from the first specific implementation described above in that the speed N2 values are also used to compute the polynomial law.

By way of a reminder, for each measurement time, within the study time zone, a temperature value V_TOIL, a differential pressure value V_PFDP and a speed N2 value V_N2 are measured, forming a triplet of measured values.

Again, in a preliminary phase, not illustrated and performed before the algorithm in FIG. 3, the prediction model is developed by processing a significant amount of data relating to flights previously taken by one or more aircraft. In this second specific implementation, the polynomial law aims to approximate triplets of values (V_TOIL, V_PFDP, V_N2) measured at times within study time zones, included in the time periods of flights previously taken by one or more aircraft. It expresses a reference differential pressure value for oil V_OFDP_REF as a function of the oil temperature (V_TOIL) and the speed N2 (V_N2).

In a phase of executing the algorithm in FIG. 3 (algorithm for monitoring the performance of an oil filter of an aircraft), the prediction model (previously developed as described above) is used in step 302 by the system 101 in order to estimate, for each measurement time, a reference differential pressure value V_OFDP_REF.

Then, in step 303, the computation of a comparison value V_COMP includes, for each measurement time at which a given triplet of measured values (V_TOIL, V_OFDP, V_N2) is measured, computing a ratio RATIO between the measured differential pressure value V_OFDP and the reference differential pressure value V_OFDP_REF (provided by the polynomial law for the measured temperature value V_TOIL and the measured speed N2 value V_N2):

$$RATIO = V\_OFDP / V\_OFDP \_REF$$

In step 304, the value forming an indicator V_INDIC is the median value RATIO_MEDIAN of the ratios RATIO computed for the various measurement times.

In step 305, the normalization of the value forming an indicator V_INDIC comprises, in order to obtain the normalized value forming an indicator V_INDIC_NORM, a multiplication:
of the value forming an indicator V_INDIC,
by the reference differential pressure value V_OFDP_REF provided by the polynomial law for an oil temperature V_TOIL_MEDIAN (equal to a median value of temperature values V_TOIL measured during previous flights by one or more aircraft) and for a speed N2 V_N2_MEDIAN (equal to a median value of speed N2 values V_N2 measured during previous flights by one or more aircraft).

Thus, with such normalization, the metric fed back (V_INDIC_NORM) by the algorithm refers to differential pressure values that can be observed on an oil filter. This metric is therefore easier to understand by the maintenance personnel who read it and receive the alerts.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for monitoring performance of an oil filter of an aircraft, the aircraft comprising a temperature sensor and a differential pressure sensor, respectively for providing measured temperature values and measured differential pressure values of oil passing through the oil filter, the method being implemented by a system for monitoring the performance of the oil filter in a form of electronic circuitry, the method comprising:
for at least one predetermined measurement time, acquiring a measured temperature value and a measured differential pressure value of the oil passing through the oil filter;
estimating, for the one or each measurement time, a reference differential pressure value using a prediction model and the measured temperature value;
computing, for the one or each measurement time, a comparison value between the measured differential pressure value and the reference differential pressure value; and
triggering an alert if a trigger condition, which is dependent on the one or more comparison values computed for the one or more measurement times, is met.

2. The method according to claim 1, wherein the prediction model is a polynomial law intended to approximate pairs of values, comprising a measured temperature value and a measured differential pressure value, measured at predefined measurement times during flights preceding a current flight, and expressing a reference differential pressure value of the oil as a function of the oil temperature.

3. The method according to claim 1, wherein at least two comparison values are computed for at least two measurement times, wherein the method further comprises determining a value forming an indicator as a function of the at least two computed comparison values, and wherein the trigger condition is a function of the value forming an indicator.

4. The method according to claim 3, comprising normalizing the value forming an indicator in order to obtain a normalized value forming an indicator, and wherein the trigger condition is a function of the normalized value forming an indicator.

5. The method according to claim 3, wherein operations prior to triggering an alert and resulting in the determination of a value forming an indicator are repeated N times, for N successive flights, with N>2, in order to obtain N values forming an indicator, and wherein the trigger condition is that an average of the N values forming an indicator is greater than a threshold value.

6. The method according to claim 1, wherein the at least one predetermined measurement time belongs to a study time zone comprising one or more study sub-time zones defined as a function of at least one criterion selected from the group consisting of:
a criterion dependent on a flight phase parameter of the aircraft;
a criterion dependent on an altitude parameter of the aircraft; and
a criterion dependent on a parameter of a speed N2 of rotation of a high-pressure rotor of an engine of the aircraft.

7. The method according to claim 3, wherein computation of a comparison value comprises, for each measurement time, a computation of a deviation between the measured differential pressure value and the reference differential pressure value, and wherein the value forming an indicator is the differential pressure value measured at the measurement time at which the computed deviation is minimal.

8. The method according to claim 3, wherein the aircraft also comprises a speed N2 sensor providing values of a speed N2 of rotation of a high-pressure rotor of an engine of the aircraft,
wherein a measured speed N2 value is also acquired for each measurement time,
wherein the estimation, for each measurement time, of a reference differential pressure value using the prediction model and the measured temperature value is also performed using the measured speed N2 value,
wherein computation of a comparison value comprises, for each measurement time, computing a ratio between the measured differential pressure value and the reference differential pressure value, and
wherein the value forming an indicator is a median value of ratios computed for the at least two measurement times.

9. A computer program product comprising instructions causing a processor to execute the method according to claim 1, when the instructions are executed by the processor.

10. A system for monitoring performance of an oil filter of an aircraft, the aircraft comprising a temperature sensor and a differential pressure sensor, respectively for providing measured temperature values and measured differential pressure values of oil passing through the oil filter, the monitoring system comprising electronic circuitry configured to implement:
for at least one predetermined measurement time, acquiring a measured temperature value and a measured differential pressure value of the oil passing through the oil filter;
estimating, for the one or each measurement time, a reference differential pressure value using a prediction model and the measured temperature value;
computing, for the one or each measurement time, a comparison value between the measured differential pressure value and the reference differential pressure value; and
triggering an alert if a trigger condition, which is dependent on the one or more comparison values computed for the one or more measurement times, is met.
